(19) United States
(12) Patent Application Publication
(10) Pub. No.: US 2022/0308213 A1
(43) Pub. Date: Sep. 29, 2022

(54) MEASUREMENT SYSTEM, MEASUREMENT APPARATUS, AND MEASUREMENT METHOD

(71) Applicant: FUJITSU LIMITED, Kawasaki-shi (JP)

(72) Inventors: Katsushi Sakai, Zama (JP); Koichi Tezuka, Shibuya (JP)

(73) Assignee: FUJITSU LIMITED, Kawasaki-shi (JP)

(21) Appl. No.: 17/559,537

(22) Filed: Dec. 22, 2021

(30) Foreign Application Priority Data
Mar. 26, 2021 (JP) 2021-053989

(51) Int. Cl. G01S 17/10; G01S 17/42; G01V 8/10; A63B 24/00

(52) U.S. Cl. CPC G01S 17/10; G01S 17/42; G01V 8/10; A63B 24/0003; A63B 2220/83; A63B 2220/805; A63B 2220/62

(57) ABSTRACT

A measurement system including a plurality of measurement apparatuses configured to cooperate to measure a measurement target moving, with a MEMS mirror performing raster scanning using laser beams with a same wavelength and with a synchronized measurement period, wherein of the plurality of measurement apparatuses, a first measurement apparatus corresponding to a detected position of the measurement target emits the laser beam onto the measurement target in the measurement period, to measure a distance to the measurement target based on a reflected beam from the measurement target, and while the first measurement apparatus is emitting the laser beam onto the measurement target in the measurement period, a second measurement apparatus different from the first measurement apparatus emits the laser beam in a period other than the measurement period.

### CROSS-REFERENCE TO RELATED APPLICATION

This application is based upon and claims the benefit of priority of the prior Japanese Patent Application No. 2021-53989, filed on Mar. 26, 2021, the entire contents of which are incorporated herein by reference.

### FIELD

The embodiments discussed herein are related to a measurement system, a measurement apparatus, and a measurement method for measuring a measurement target.

### BACKGROUND

There is a measurement system in which a plurality of measurement devices, examples of which include a plurality of laser measurement devices, cooperate to measure a moving measurement target. For example, among a plurality of laser measurement devices, a laser measurement device corresponding to the position of the measurement target emits a laser beam, and the reflected beam from the measurement target is detected and analyzed, whereby three-dimensional data on a measurement target may be acquired in a non-contact manner.

For example, such a measurement system is used for the scoring of athletes moving during their artistic gymnastics performance. Currently, a plurality of judges visually score the artistic gymnastics. However, due to the ongoing sophistication of elements in recent years, cases where the visual scoring by the judges face difficulties have been increasing. By using the measurement system, information on elements and the like performed by a moving athlete may be recognized based on the three-dimensional data on the athlete. Then, with the information on their posture and the like provided, the judges may be assisted in their scoring.

An example of a known measurement technique using a laser beam includes a time-of-flight (TOF) distance measurement technique. With the technique, testing is performed on a photodetector or an obstacle, with laser beams of colors red, green, and blue as well as an infrared laser beam emitted onto a target through raster scanning using a MEMS mirror. Among the beams, the infrared laser beam is driven in a flyback period. MEMS is short for micro electro mechanical systems. In the MEMS, after the raster scanning has been performed for scanning in horizontal and vertical directions from a scanning start position using the mirror, the mirror returns to the scanning start position during the flyback period for the vertical direction. TOF is short for laser time of flight. There is a technique of combining light beams from light sources of different wavelengths, and performing two-dimensional scanning with the resultant light beam using a MEMS mirror.

Examples of the related art include as follows: Japanese National Publication of International Patent Application No. 2017-504047; and Japanese Laid-open Patent Publication No. 2012-008193.

### SUMMARY

According to an aspect of the embodiments, there is provided a measurement system including a plurality of measurement apparatuses configured to cooperate to measure a measurement target moving, with a MEMS mirror performing raster scanning using laser beams with a same wavelength and with a synchronized measurement period, wherein of the plurality of measurement apparatuses, a first measurement apparatus corresponding to a detected position of the measurement target emits the laser beam onto the measurement target in the measurement period, to measure a distance to the measurement target based on a reflected beam from the measurement target, and while the first measurement apparatus is emitting the laser beam onto the measurement target in the measurement period, a second measurement apparatus different from the first measurement apparatus emits the laser beam in a period other than the measurement period.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of measurement performed by a measurement system according to an embodiment;

FIG. 2 illustrates raster scanning by a measurement apparatus;

FIG. 3 illustrates an amplitude waveform of a MEMS;

FIG. 4 is an explanatory diagram illustrating distortion generated in a distance measurement image due to a variation in an amplitude;

FIG. 5 illustrates a comparison between MEMS amplitude amounts;

FIGS. 6A and 6B illustrate an arrangement configuration example of measurement apparatuses;

FIG. 7 is an explanatory diagram illustrating flyback control according to the embodiment;

FIG. 8 illustrates a configuration example of a measurement system according to the embodiment;

FIG. 9 illustrates a hardware configuration example of a controller;

FIG. 10 is a flowchart illustrating a processing example of the measurement system according to the embodiment;

FIG. 11A is an explanatory diagram (first) illustrating a measurement state of the measurement apparatuses during a movement of the measurement target;

FIG. 11B is an explanatory diagram (first) illustrating a laser beam emission state of the measurement apparatuses during the movement of the measurement target;

FIG. 12A is an explanatory diagram (second) illustrating a measurement state of the measurement apparatuses during the movement of the measurement target;

FIG. 12B is an explanatory diagram (second) illustrating a laser beam emission state of the measurement apparatuses during the movement of the measurement target;

FIG. 13 illustrates transition of laser beam emission states of a plurality of measurement apparatuses; and

FIG. 14 illustrates an example of selection of a measurement apparatus in response to a movement of the measurement target.

### DESCRIPTION OF EMBODIMENTS

In a case where a movement of a measurement target is detected and a plurality of laser measurement devices cooperate to perform measurement, into a laser measurement device performing the measurement, a reflected beam that is a laser beam emitted from another laser measurement device and reflected by the measurement target may enter. In this case, there is a problem in that the measurement fails to be accurately performed, due to the laser beam emitted by the other laser measurement device interfering with the measurement by the laser measurement device performing the measurement.

To suppress the interference, a physical shutter may be provided and opened/closed to control the laser beam. However, this requires a special shutter mechanism and shutter control, leading to a cost increase. Furthermore, an angle of the MEMS mirror and the like may be controlled at the time when the interference is detected to suppress the interference, but in this case, the MEMS control is always performed after the interference is detected by a sensor and the like. In addition to the control delay in this case, due to the unique characteristics of the MEMS mirror such as amplitude characteristics varying depending on the presence/absence of the energy of the reflected beam for example, it takes time to implement stable measurement. Furthermore, to suppress the interference, a configuration may be employed in which laser beams of a plurality of laser measurement devices differ from one another in frequency (wavelength), but this leads to a cost increase.

Simply stopping the laser beam emission of the other laser measurement device cooperating with the laser measurement device performing the measurement results in a long time required for stabilizing the amplitude of the MEMS mirror after resumption of the measurement by the other laser measurement device the laser beam emission from which has been stopped. For example, a measurement target such as an athlete of artistic gymnastics moves in unpredictable directions, meaning that the other laser measurement device the laser beam emission from which has been stopped may measure the measurement target (athlete) in the subsequent period.

Thus, in a case where a plurality of laser measurement devices cooperate to measure a moving measurement target, interference with the laser measurement device performing the measurement is not easily removable with the known techniques. Furthermore, the measurement by the other laser measurement device the laser beam from which has been stopped is unable to immediately start. All things considered, with the known techniques, stable and interference-free measurement for a measurement target moving in unpredictable directions has not been achievable, and improvement in measurement accuracy has not been achievable.

According to one aspect, an object of the embodiments is to enable stable measurement corresponding to a movement of a measurement target, without interference between laser beams.

(Embodiments)

Hereinafter, embodiments of a measurement system, a measurement apparatus, and a measurement method according to the present disclosure are described in detail with reference to the drawings.

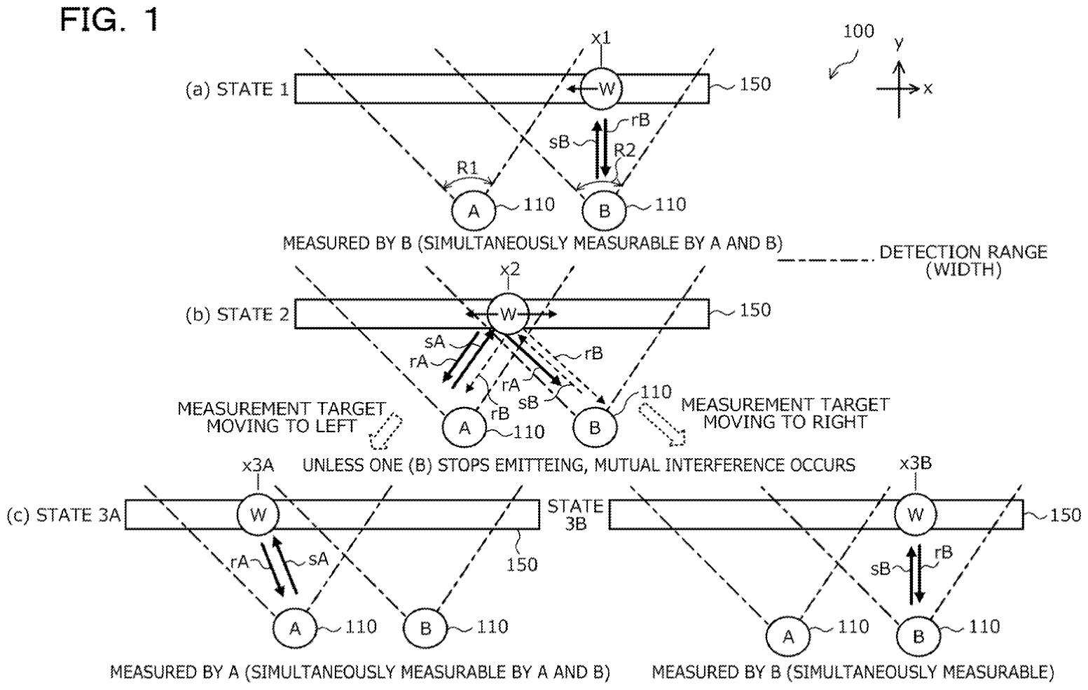

FIG. 1 is an explanatory diagram illustrating an example of measurement performed by a measurement system according to an embodiment. An example of measurement using a plurality of laser beams and an example of laser beam interference will be described with reference to FIG. 1. A measurement system 100 illustrated in FIG. 1 measures, for example, a movement or the like of an athlete (measurement target) W performing artistic gymnastics on a balance beam 150 by laser distance measurement. The measurement system 100 according to the embodiment includes a plurality of measurement apparatuses 110. Although an example illustrated in FIG. 1 is an example in which two measurement apparatuses 110 (A, B) are arranged, this is for the sake of description, and a configuration in which three or more such apparatuses are arranged may be employed.

Each of the measurement apparatuses A and B (110) includes a detection unit that detects the position of the athlete W. This is not to be construed in a limiting sense, and the detection unit may be disposed as a detection device outside the measurement apparatuses A and B (110). The athlete W performing artistic gymnastics, implements various elements while moving back and forth along an X-axis direction along the length of the balance beam 150.

Each of the measurement apparatuses A and B (110) performs raster scanning with a laser beam (measurement beam) by using MEMS. Thus, the laser beam, with a radial detection range (horizontal scanning direction) R, is emitted toward the balance beam 150 (the moving athlete W). The measurement apparatuses A and B (110) are arranged to have their respective detection ranges R1 and R2 partially overlap to correspond to the athlete W moving on the balance beam 150.

During a measurement period, the two measurement apparatuses A and B (110) are under synchronization control to cooperate with each other, and thus emit the laser beams with the detection ranges R1 and R2 at the same timing (measurement interval). For example, with the two measurement apparatuses A and B (110) thus cooperating with each other, information such as a laser beam emission state of one measurement apparatus A (110) is notified to the other measurement apparatus B (110), using a control signal.

In the measurement system 100 according to the embodiment, the measurement apparatuses A and B (110) emit laser beams with the same wavelength (oscillation frequency). The detection unit detects the position of the athlete W on the balance beam 150, and the measurement apparatuses A and B (110) control the emission (emit/stop) of the laser beams in accordance with the position of the athlete W.

(a) to (c) in FIG. 1 respectively illustrate a state 1 to a state 3 of the athlete W moving on the balance beam 150. The state 1 illustrated in (a) in

FIG. 1 is a state in which the athlete W is located at a detected position x1 of the measurement apparatus B (110). In this state 1, no interference occurs even when both of the measurement apparatuses A and B (110) simultaneously emit the laser beams with the detection ranges R1 and R2. For example, when the athlete W is located at the detected position x1 in the state 1, a laser beam (measurement beam) sB from the measurement apparatus B is reflected only to the measurement apparatus B (110), meaning that a reflected beam rB does not enter the measurement apparatus A (110), whereby interference with the measurement apparatus A (110) does not occur.

The state 2 illustrated in (b) in FIG. 1 is a state in which the athlete

W is located at a detected position x2 to be detected by both of the measurement apparatuses A and B (110). In this state 2, when a reflected beam rA of a laser beam (measurement beam) sA emitted from the measurement apparatus A (110) and onto the athlete W enters the measurement apparatus B (110), measurement by the measurement apparatus B (110) is interfered with.

Similarly, when a reflected beam rB of the laser beam (measurement beam) sB, emitted from the measurement apparatus B (110) and onto the athlete W, enters the measurement apparatus A (110), measurement by the measurement apparatus A (110) is interfered with.

As described above, in the state 2 illustrated in (b) in FIG. 1, unless the laser beam emission from one measurement apparatus 110 of the two measurement apparatuses A and B (110) is stopped, the measurement by the other measurement apparatus 110 is interfered with. In the embodiment, when the athlete W is located at the detected position x2 in the case of the state 2, control is performed to stop the emission of the laser beam from one measurement apparatus 110 of the two measurement apparatuses A and B (110). For example, in the case of the state 2 illustrated in (b) in FIG. 1, control is performed to stop the emission of the laser beam sB from the measurement apparatus B (110), while the measurement apparatus A (110) is performing measurements on the athlete W with the laser beam sA emitted from the measurement apparatus A (110).

To deal with the case of the state 2, the two measurement apparatuses A and B (110) are communicably coupled to each other in advance under master/slave setting, with one of the measurement apparatuses 110 (for example, the measurement apparatus A) set to be prioritized to emit the laser beam and perform the measurement. Thus, during the measurement period in which the measurement apparatus A (110) performs the measurement using the laser beam sA, interference by (entry of) the laser beam sB (reflected beam rB) from the measurement apparatus B (110) may be suppressed.

In which direction the athlete W located at the detected position x2 moves (left/right on the x-axis direction in FIG. 1) is something only the athlete W knows, and is not detectable on the system (measurement apparatuses A and B) side. After the state 2 illustrated in (b) in FIG. 1, a movement of the athlete W toward the left side (a detected position x3A, a state 3A) or a movement of the athlete W toward the right side (a detected position x3B, a state 3B) occurs as the state 3 illustrated in (c) in FIG. 1. x3B is the same as the detected position x1 in (a) in FIG. 1.

In a state where the athlete W is located at the detected position x3A, x3B in the state 3A, 3B in (c) in FIG. 1, even when both of the measurement apparatuses A and B (110) simultaneously emit the laser beams with the detection ranges R1 and R2, no interference occurs therebetween.

The measurement apparatus A (110) that has emitted the laser beam in the state 2 in (b) in FIG. 1 may stably perform the measurement by continuously performing the laser beam emission also in the state 3A in (c) in FIG. 1. However, the measurement apparatus B (110) in the state 3B in (c) in

FIG. 1 has stopped the laser beam emission in the immediately preceding state 2 in (b) in FIG. 1, and thus is not able to perform the measurement accurately by simply resuming the laser beam emission that has been stopped. This is affected by a delay element such as a starting characteristic of a laser beam source and an amplitude characteristic of the MEMS for performing the raster scanning (details will be described later).

In view of this, in the embodiment, flyback control (feedback control) is performed on the measurement apparatus B (110) the laser beam from which has been stopped in the state 2 in (b) in FIG. 1. An overview of the flyback control according to the embodiment will be described. Basically, during the measurement period, the two measurement apparatuses A and B (110) are under the synchronization control, and thus simultaneously emit the laser beams in the same measurement period. During then, the two measurement apparatuses A and B (110) irradiate the athlete W with the laser beams with the detection ranges R1 and R2, through the raster scanning implemented with the

MEMS mirror scanning angle continuously changed. After the end of the measurement period, the two measurement apparatuses A and B (110) make the MEMS mirrors return to the initial positions (scanning angles) of the raster scanning, in a flyback control period.

In the embodiment, to suppress the interference as described above, the measurement apparatus B (110) that has stopped the laser beam during the measurement period in the state 2 illustrated in (b) in FIG. 1 emits the laser beam during the flyback control period. The flyback control period is different from the measurement period. Thus, emission of the laser beam from the measurement apparatus B (110) during the flyback control period imposes no impact such as interference on the measurement by the measurement apparatus A (110) during the measurement period. After transitioning to the measurement state as illustrated in the state 3B in (c) in FIG. 1, the measurement apparatus B (110) may perform the measurement with the laser beam emission and the raster scanning using the MEMS being stable from the start of the measurement period.

As described above, in the measurement system 100 according to the embodiment, the measurement apparatuses A and B (110) have the function of the detection unit that detects the position of the measurement target (athlete W). The measurement system 100 includes a first laser sensor (measurement apparatus A) that emits a laser beam to measure a distance to the measurement target, while the measurement target is within a first range (x3A). The measurement system 100 further includes a second laser sensor (measurement apparatus B) that emits a laser beam to measure a distance to the measurement target, while the measurement target is within a second range (x3B, x1). The second laser sensor (measurement apparatus B) receives a control signal related to whether the laser beam is emitted from the first laser sensor (measurement apparatus A) or the like, whereby cooperation control is implemented.

One laser sensor (the second laser sensor (the measurement apparatus B)) stops the laser beam emission for suppressing the interference in a case where the measurement target is at a position (third range x2) also detectable by the other laser sensor (the first laser sensor (the measurement apparatus A)). It is assumed that the measurement target has then moved in a direction from the third range (x2) toward the first range (x3A). In this case, based on the control signal from the first laser sensor, the second laser sensor (measurement apparatus B) emits the laser beam at a timing when the first laser sensor is not emitting the laser beam (in a period other than the measurement period, flyback period).

As described above, in the measurement system 100, a plurality of measurement apparatuses simultaneously emit the laser beams, having the same oscillation frequency and being configured to have the detection regions partially overlapping, onto the measurement target and perform the measurement including distance measurement by receiving the reflected beam from the measurement target. In such a measurement system 100, of the plurality of measurement apparatuses, the second laser sensor (the measurement apparatus B) the laser beam emission from which has been temporarily stopped emits the laser beam in the flyback period. Thus, stable distance measurement may be started with a predetermined laser output and the raster scanning using the MEMS, from the start of the measurement period.

When the measurement is performed using the respective laser beams from the plurality of laser sensors (measurement apparatuses A and B) with overlapping detection ranges, interference therebetween may be suppressed. Furthermore, when the measurement by the laser sensor the laser beam emission from which has been stopped starts in a state where the movement (movement state) of the measurement target (athlete W) is unidentifiable, the measurement may be stably and accurately performed immediately.

The measurement system 100 of the embodiment generates three dimensional data on a measurement target, with the plurality of measurement apparatuses A and B (110) that use laser beams cooperating with each other to simultaneously acquire measurement data on the measurement target. For example, the measurement apparatuses 110 have a laser distance measurement sensor (laser imaging detection and ranging (LIDAR)) using the MEMS to measure the speed of light.

In the above description, an example where the synchronization control is implemented for cooperation between the plurality of measurement apparatuses A and B (110) is described. This is not to be configured in a limiting sense, and a configuration may be employed in which a higher-level controller, provided separately from the plurality of measurement apparatuses A and B (110), collectively controls the laser beam emission from the measurement apparatuses A and B (110). In this case, for the plurality of measurement apparatuses A and B (110), the controller selectively controls a measurement apparatus that emits a laser beam for measurement and a measurement apparatus that is controlled in the flyback period (hold mode ON control) based on the state of the position of the athlete W detected by the detection unit.

(Cooperation configuration for plurality of measurement apparatuses and task)

A cooperation configuration for a plurality of measurement apparatuses and a task will now be described. In recent years, Internet of Things

(IoT) has become popular. As a result, systems in which a plurality of measurement apparatuses cooperate to acquire various types of data are increasing every year. These measurement apparatuses that are meant to cooperate may fail to accurately perform the measurement when a measurement condition changes in a case where avoidance of interference between the measurement apparatuses is prioritized. According to the embodiment, the cooperation between a plurality of measurement apparatuses would not affect the measurement result due to interference or the like, whereby robustness against a change in the measurement condition (robustness against disturbance) is achieved.

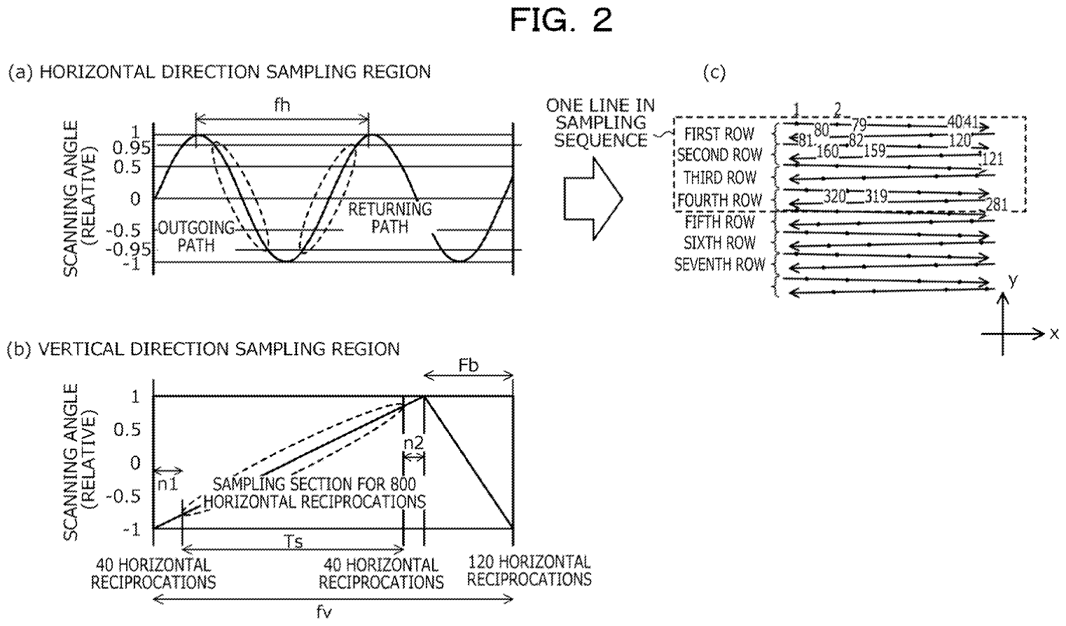

FIG. 2 illustrates raster scanning by the measurement apparatus. With the plurality of measurement apparatuses cooperating, the plurality of measurement apparatuses simultaneously emit the laser beams under the synchronization control described above to perform the measurement. (a) in FIG. 2 illustrates a horizontal direction sampling region (the horizontal axis represents time and the vertical axis represents the scanning angle of the laser beam in the horizontal direction). (b) in FIG. 2 illustrates a vertical direction sampling region (the horizontal axis represents time (a horizontal reciprocal scanning period during which the MEMS reciprocates 200 times) and the vertical axis represents the scanning angle of the laser beam in the vertical direction). (c) in FIG. 2 illustrates a position of sampling data on a MEMS surface (x and y axes).

The sampling count per frame is 64000 points (raster scanning (progressive) with 320 points in the x axis x 200 points in the y axis), the MEMS driving resonance frequency fh (amplitude) is about 28.3 Hz (one cycle, one frame data), and the data sampling is 3.2 MHz. There are 30 frames per second.

As illustrated in (a) in FIG. 2, the MEMS vibrates, in response to a driving signal, at the unique frequency fh (for example, about 28.3 kHz) in the horizontal direction, to sample 80 points at a 320-ns fixed sampling interval in a single section of a pair of outgoing/returning paths. The MEMS samples 320 points through four reciprocations in the horizontal direction (see (c) in FIG. 2).

The MEMS generates a sampling start trigger for each section based on a sensor signal of the MEMS. As a result, as illustrated in (c) in FIG. 2, sampling data at 320 points is acquired through four reciprocations. The sampling is performed for 80 points during a single reciprocation, and with a horizontal angle shifted between reciprocations to fill gaps.

As illustrated in (b) in FIG. 2, the MEMS vibrates, in response to a driving signal, at a unique frequency fv (for example, about 28.3 Hz) in the vertical direction. In the entire period of the horizontal reciprocation (total of 200 reciprocations), the MEMS increases the scanning angle during a measurement period Ts, and reduces the scanning angle during a period (corresponding to a flyback period Fb) other than the measurement period Ts. Predetermined periods (each corresponding to 40 horizontal reciprocations) respectively at the start and the end of the period during which the scanning angle increases are set to be dead zones n1 (40 horizontal reciprocations) and n2 (40 horizontal reciprocations) not used for the measurement, for removing the impact of the amplitude. A sampling section for 800 horizontal reciprocations excluding the dead zones n1 and n2 is set as the measurement period Ts. The flyback period Fb corresponds to 120 horizontal reciprocations. Each of the dead zones n1 and n2 is a period in which no light is emitted in a horizontal resonance direction of the MEMS mirror.

With the synchronization control under which the plurality of measurement apparatuses A and B (110) cooperate with each other, the emission of laser beams is strictly synchronized for each frame data, and the emission timings are controlled so that no interference occurs therebetween. Still, as illustrated in the state 2 in (b) in FIG. 1, interference with the measurement signal may occur, depending on the arrangement layout of the measurement target (athlete W) and the measurement apparatuses A and B (110) and the like. In view of this, when one measurement apparatus A (110) is performing measurement in the measurement period Ts, the emission of the laser beam by the other measurement apparatus B (110) is stopped so as not to affect the measurement by the one measurement apparatus A (110).

In a case where measurement is performed with the other measurement apparatus B (110), the laser beam emission from which has been temporarily stopped, resuming the laser beam emission (corresponding to the state 3B in (c) in FIG. 1), several frames are required for stabilizing the amplitude of the MEMS, due to an impact of the laser beam.

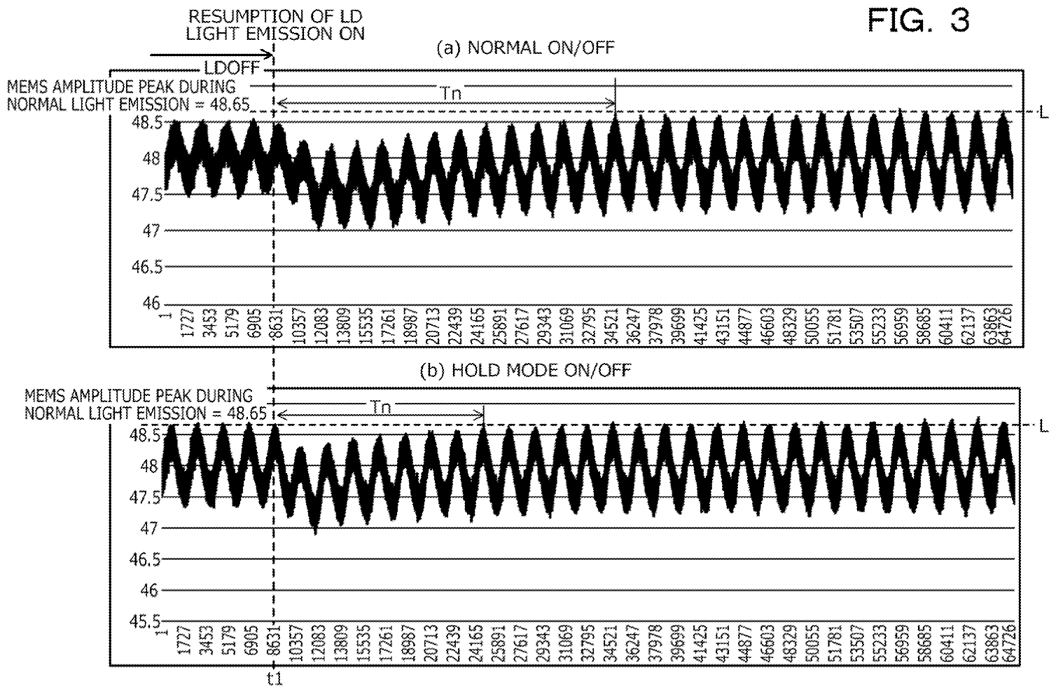

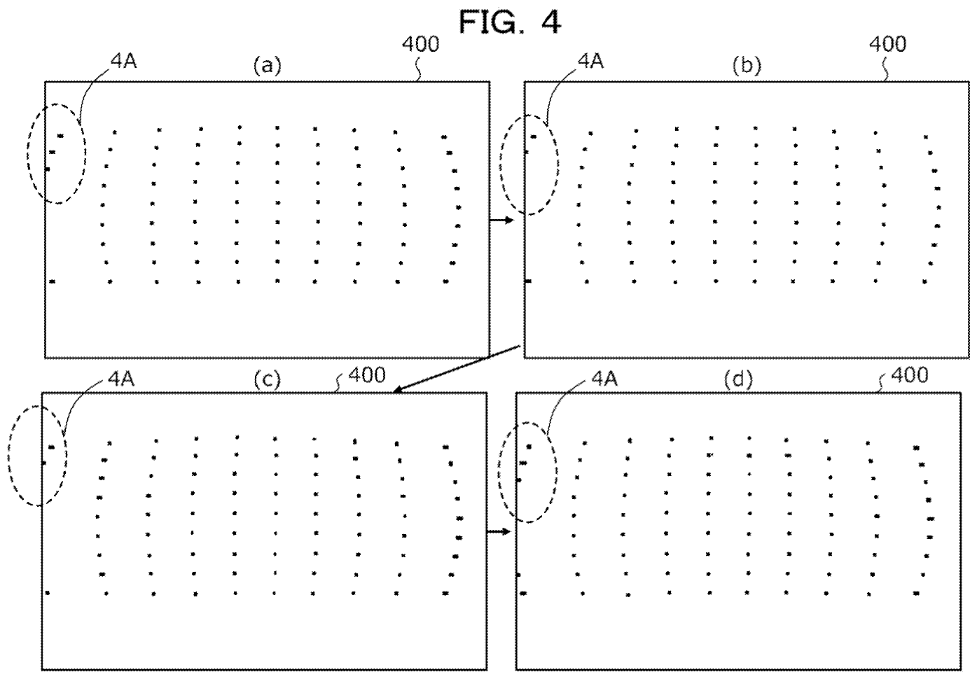

FIG. 3 illustrates an amplitude waveform of the MEMS. FIG. 4 is an explanatory diagram illustrating distortion generated in a distance measurement image due to a variation in the amplitude. In FIG. 3, the horizontal axis represents time and the vertical axis represents amplitude. (a) in FIG. 3 illustrates an amplitude state as a result of switching the laser beam from OFF to ON. (b) in FIG. 3 illustrates an amplitude state with the hold mode turned ON/OFF.

The measurement apparatus 110 performs measurement in a normal mode. The measurement apparatus 110 that interferes with the measurement in the normal mode transitions to the hold mode. The measurement apparatus 110 in the hold mode stops the laser beam emission during the measurement period Ts, and performs the laser beam emission in a period other than the measurement period Ts, which is, for example, the flyback period Fb. All the measurement apparatuses A and B (110) of the measurement system 100 simultaneously perform the laser beam emission during the measurement period Ts.

(a) in FIG. 3 illustrates, as an example of normal ON/OFF control, an amplitude waveform in a state where the laser beam is turned ON at a timing t1 after a laser beam OFF state. Due to disturbance, the MEMS is in a period Tn in which the amplitude is smaller than a specified amplitude (an amplitude L (MEMS amplitude peak value 48.65 mV) in the figure), for a predetermined delay time (corresponding to six frames for example).

As described above, the laser beam scanning using the MEMS is performed with the MEMS mirror oscillating (vibrating) by being driven at a predetermined resonance frequency. The amplitude of the MEMS mirror varies depending on presence or absence of energy of the reflected beam. It takes time until the variation in amplitude due to the presence or absence of the laser beam is stabilized. Additionally, a position signal of the MEMS includes a large amount of noise causing an overshoot and the like even when the amplitude control is performed on the MEMS mirror, and thus a time corresponding to several frames is required until the stable state is restored.

FIG. 4 illustrates an example of a distance measurement image generated obtained when the laser beam described with reference to (a) in FIG. 3 is turned from OFF to ON. (a) to (d) in FIG. 4 illustrate examples of a display image 400 of marks (points) the respective distances at which are measured at a predetermined time interval. When images over first several frames after the laser beam has been turned ON are distorted, distortion occurs in the distance measurement image. For example, marks at three points are displayed in a region 4A in (a) in FIG. 4. Due to the distortion of the image, the marks in the region 4A are at two points in (b) and (c) in FIG. 4. In (d) in FIG. 4, the marks are again displayed at three points in the region 4A.

As described above, due to a failure to acquire desired measurement points (measurement data corresponding to the image of the mark position portion described above) or due to occurrence of residual deviation, when the laser beam is turned ON from OFF, the distance measurement may fail to be accurately performed. The recognition of the measurement target (athlete W) is affected due to a failure to follow the moving action of the measurement target (athlete W).

In view of the above, in the embodiment, as illustrated in the state 2 in (b) in FIG. 1, the laser beam emission from the other measurement apparatus B (110) is turned OFF in a case where one measurement apparatus A (110) on the measurement side is otherwise interfered by the laser beam from the other measurement apparatus B (110). The laser beam emission from the other measurement apparatus B (110) is turned OFF, but is OFF only during the measurement period Ts. The laser beam emission is performed in the other period, the flyback period Fb which is a period during which the scanning (angle) of the MEMS mirror returns to the emission starting point (original position).

(b) in FIG. 3 illustrates the MEMS amplitude waveform (hold mode ON/OFF) in this case. As illustrated in (b) in FIG. 3, a delay time after the laser beam has been turned ON at the timing t1 following the state in which the laser beam is OFF is shorter than that illustrated in (a) in FIG. 3. Furthermore, a difference between the MEMS amplitude and the specified amplitude (the amplitude L in the figure) may be further reduced. With the laser beam emitted during the flyback period Fb under the hold mode, the MEMS has the specified amplitude (the amplitude L in the figure) at the start of the measurement period Ts.

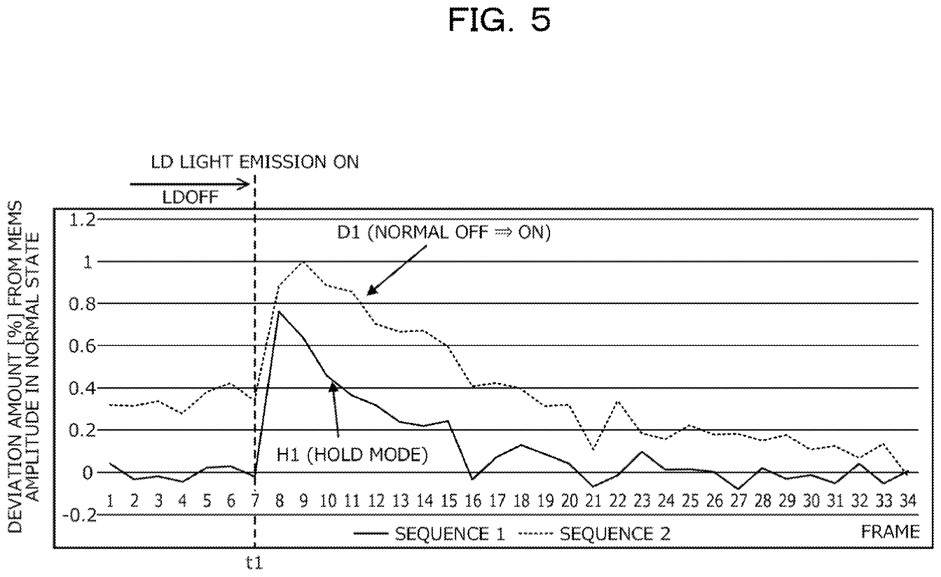

FIG. 5 illustrates a comparison between MEMS amplitude amounts. A comparison between the MEMS amplitude amounts respectively obtained with the normal ON/OFF (corresponding to (a) in FIG. 3) and with the hold mode

ON/OFF (corresponding to (b) in FIG. 3) described above is illustrated. The horizontal axis represents time (the number of frames), and the vertical axis represents a deviation amount (%) from the MEMS amplitude in the normal state. According to a characteristic D1 of the normal ON/OFF control, before the laser beam emission is resumed (turned ON) at the timing t1, MEMS amplitude deviation of about 0.4% is already occurring, and deviation of about 0.9 to 1% is occurring over four frames. For this reason, with the characteristic D1, about 30 frames are required for returning to the normal MEMS amplitude (amplitude amount).

According to a characteristic H1 of the hold mode (light emitted 128 times at an interval of 100 ns) in the embodiment, the MEMS amplitude (amplitude amount) is maintained also during the hold mode (LDOFF). Thus, the deviation is about 0.75% in the first frame (the 8th frame in total) after the resumption of the laser beam emission at the timing t1. Then, the deviation swiftly decreases frame by frame to 0.6%, 0.45%, . . . , and the restoration to the original state is completed in the 9th frame (the 16th frame in total).

In this manner, in the embodiment, while one measurement apparatus A (110) of the cooperating measurement apparatuses A and B (110) is performing the measurement, the other measurement apparatus B (110) stops the laser beam emission in the measurement period Ts. The other measurement apparatus B (110) the laser beam emission from which has been stopped performs the laser beam emission in the flyback period Fb immediately before the start of the measurement. Thus, at the start of the measurement period Ts, stable measurement may be immediately performed with the MEMS having the specified amplitude.

(Example of arrangement of plurality of measurement apparatuses and interference state)

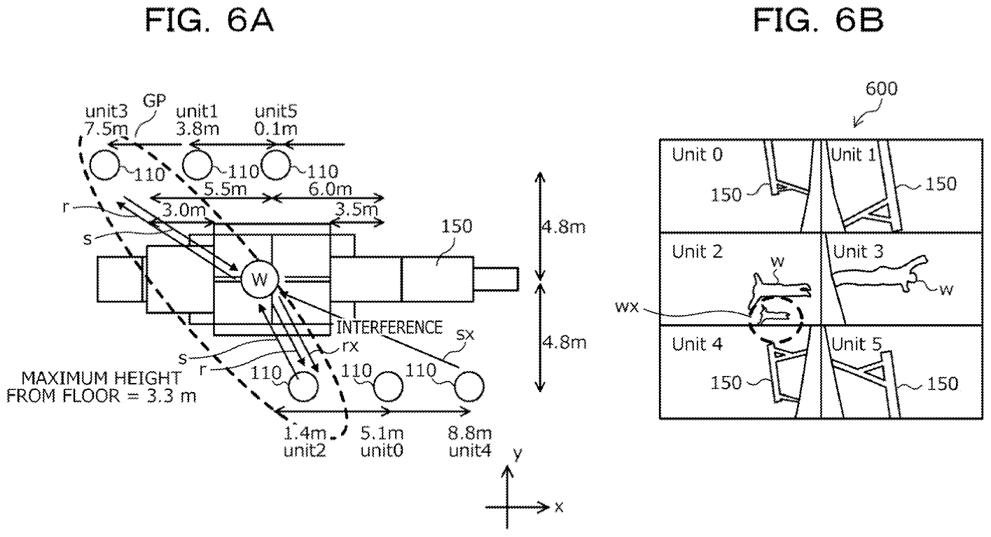

FIG. 6 (i.e., FIGS. 6A and 6B) illustrates an arrangement configuration example of the measurement apparatuses. For convenience, in FIG. 1, how interference occurs is described with the arrangement of the two measurement apparatuses 110. (a) in FIG. 6 illustrates an example of dimensions of parts of the balance beam 150, and an example of an arrangement interval of the measurement apparatuses 110 with respect to the balance beam 150, in plan view. As illustrated in (a) in FIG. 6, the measurement system 100 includes a larger number (six in the illustrated example) of measurement apparatuses 110. Under the cooperation control that is the same as the one described above, the six measurement apparatuses 110 emit the laser beams with the same laser wavelength, at the same timing (measurement interval), onto the measurement target (athlete W).

A plurality of measurement apparatuses 110 are disposed at front and back positions on a direction (y axis) orthogonal to the length direction (x axis) of the balance beam 150, with the balance beam 150 disposed at the center. The front and back are in directions directly opposite to each other. For example, the measurement apparatuses 110 that are Unit 2, Unit 0, and Unit 4 are disposed at a predetermined interval, on the front side (lower side on the y axis in the figure) of the balance beam 150. The measurement apparatuses 110 that are Unit 3, Unit 1, and Unit 5 are disposed at a predetermined interval, on the back side (upper side on the y axis in the figure) of the balance beam 150.

The measurement apparatuses A and B are arranged only on the front side of the balance beam 150 in the configuration described with reference to FIG. 1, whereas the plurality of measurement apparatuses 110 are arranged on both front and back sides of the balance beam 150 in the example illustrated in (a) in FIG. 6. With the measurement apparatuses 110 thus arranged on both front and back sides (both sides) of the balance beam 150, the measurement target (athlete W) may be measured with accuracy higher than that with the one-side arrangement.

Each pair of front and back measurement apparatuses 110 have the laser beam emission direction and the detection direction set with a predetermined angle (inclined) with respect to the length direction (x axis) of the balance beam 150, and are arranged with interference between the measurement apparatuses 110 suppressed as much as possible.

It is assumed that the measurement system 100 performs measurement by selecting a pair of front and back measurement apparatuses 110 to be in a group, in accordance with the position of the athlete W on the balance beam 150. In the example illustrated in (a) in FIG. 6, the pair of measurement apparatuses 110 (Unit 2, Unit 3) selected to be in a group GP emit laser beams (measurement beams) onto the measurement target (athlete W).

A state in which interference occurs in the configuration example illustrated in (a) in FIG. 6 will be described. At the time when the position of the athlete W on the balance beam 150 is detected as illustrated in (a) in FIG. 6, the measurement is performed using laser beams (measurement beams s) emitted from the measurement apparatuses 110 that are Unit 2 and Unit 3 selected to be in the group GP. Each of the pair of measurement apparatuses 110 (Unit 2 and Unit 3) selected to be in the group GP receives a reflected beam r on substantially the same path as the measurement beam s emitted onto the athlete W.

(a) in FIG. 6 illustrates a state in which the interference is occurring with a reflected beam (scattered light) rx, as a result of irradiating the athlete W with a measurement beam sx emitted from another measurement apparatus 110

(Unit 4) not selected to be in the group GP entering Unit 2. The reflected beam (scattered light) rx is reflected to be in a path (angle) different from that of the measurement beam sx with which the athlete W is irradiated. For example, due to a change in the position or posture of the athlete W on the balance beam 150 or the like, interference between the measurement apparatuses 110 selected to be in the group GP and another measurement apparatus 110 may occur.

(b) in FIG. 6 illustrates a measurement image using measurement data of each measurement apparatus. Through imaging processing on measurement data pieces obtained by measurement by the respective measurement apparatuses 110 (Unit 0 to Unit 5), measurement images 600 of the balance beam 150 and the athlete W are generated as illustrated in (b) in FIG. 6.

An outer edge image w indicating the body shape of the athlete W is displayed in each of the measurement images 600 obtained by Unit2 and Unit3 selected to be in the group GP. In the measurement image 600 obtained by Unit 2, a small interference image wx due to the influence of the reflected beam rx of Unit 4 is displayed in addition to the outer edge image w indicating the body shape of the athlete W captured by Unit 2. The interference image wx is an outer edge image indicating the body shape of the athlete W. Due to the occurrence of such interference, the unwanted interference image wx due to the reflected beam (scattered light) rx may be included in the image data obtained by the measurement apparatus 110 (Unit 2) selected to be in the group GP performing the measurement. The image data, illustrated in black and white in the example illustrated in (b) in FIG. 6, is displayed in a plurality of different colors corresponding to the distances from the measurement apparatus 110 to the measurement target.

With reference to FIG. 6, an example is described in which the measurement apparatus 110 selected to be in the group GP performing the measurement is interfered by another measurement apparatus 110 not selected to be in the group GP. The interference occurs even when the position of the athlete W is the same, if the reflected beam (scattered light) rx has the reflection direction changing due to a change in the posture or the facing direction and the like and enters the measurement apparatus 110 performing the measurement.

Thus, during the measurement using the pair of measurement apparatuses 110 selected to be in the group GP, the measurement apparatuses 110 selected to be in the group GP may be interfered by any other measurement apparatuses 110 not selected to be in the group GP.

In view of this, in the embodiment, the hold mode is turned ON for all the measurement apparatuses 110 other than the measurement apparatuses 110 selected to be in the group GP. As a result, during the measurement period Ts of the measurement apparatuses 110 selected to be in the group GP, the emission of the measurement beams sx from the other measurement apparatuses 110 is stopped, thereby suppressing interference due to unwanted entry of the reflected beam (scattered light) rx into the measurement apparatuses 110 selected to be in the group GP.

In the example illustrated (a) in FIG. 6, in the measurement system 100, the measurement apparatuses 110 that are a pair of Unit 2 and Unit 3 selected to be in the group GP emit laser beams (measurement beams s) onto the athlete W. At this time, the measurement system 100 stops the emission of the measurement beams sx from the other measurement apparatuses 110 (Unit 0, Unit 1, Unit 4, and Unit 5) not selected to be in the group GP. Thus, interference due to unwanted entry of the reflected beam (scattered light) rx from another measurement apparatus 110 into the measurement apparatuses 110 selected to be in the group GP is suppressed.

(Flyback control)

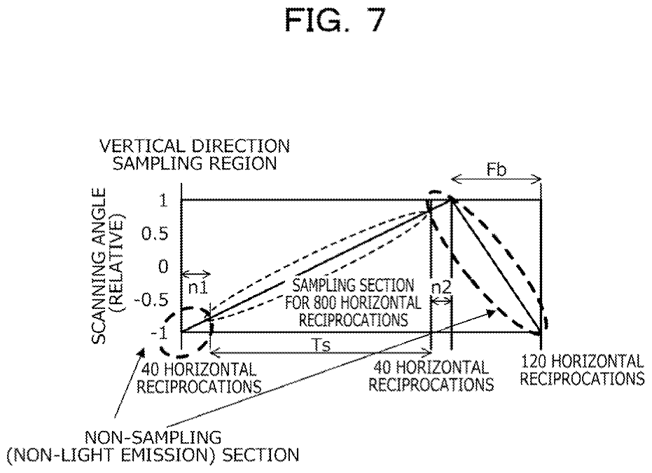

FIG. 7 is an explanatory diagram illustrating the flyback control according to the embodiment. The vertical direction sampling region (the horizontal axis represents time (a horizontal reciprocal scanning period during which the MEMS reciprocates 200 times) and the vertical axis represents the scanning angle of the laser beam in the vertical direction) is illustrated.

According to the embodiment, the measurement apparatus 110 the laser beam emission from which has been stopped with the hold mode turned ON for interference suppression stops the laser beam emission in the measurement period Ts, and performs the laser beam emission in the flyback period Fb, which is an example of a period other than the measurement period Ts.

With the laser beam emission of the measurement apparatus 110 that is the target of the hold mode ON control, turned OFF in the measurement period Ts and turned ON in a period other than the measurement period Ts, the impact of the interference due to the reflection of the laser beam with the MEMS resonance amplitude may be suppressed. No interference occurs because all of the plurality of measurement apparatuses 110 are in a non-measurement period during the period (flyback period Fb) in which the laser beam emission is turned ON

During the period in which the laser beam emission is ON, the measurement apparatus 110 that is the target of the hold mode ON control increases the power of the laser beam to be emitted, toward the energy during the measurement period Ts.

One or both of the dead zones n1 and n2 before and after the flyback period Fb may be added as the period in which the laser beam emission is turned ON under the hold mode ON control. For example, because the number of reflected beam points in the flyback period Fb alone is smaller than that in the normal sampling period, the dead zones n1 and n2 before and after the flyback period Fb are included for suppressing residual deviation at the time of resumption of the laser beam emission and the like. In this case, for example, the sampling interval is 320 ns×(40 reciprocations (n1)+40 reciprocations (n2)+120 reciprocations (Fb)/800 reciprocations (Ts)=80 ns. Thus, when the laser beam emission is turned ON, the laser beam is emitted at the interval of 80 ns. Thus, the energy during the period in which the laser beam emission is turned ON under the hold mode ON control may be made equivalent to the energy in the measurement period Ts, whereby the amplitude of the MEMS mirror may be stabilized.

(Configuration Example of Measurement System)

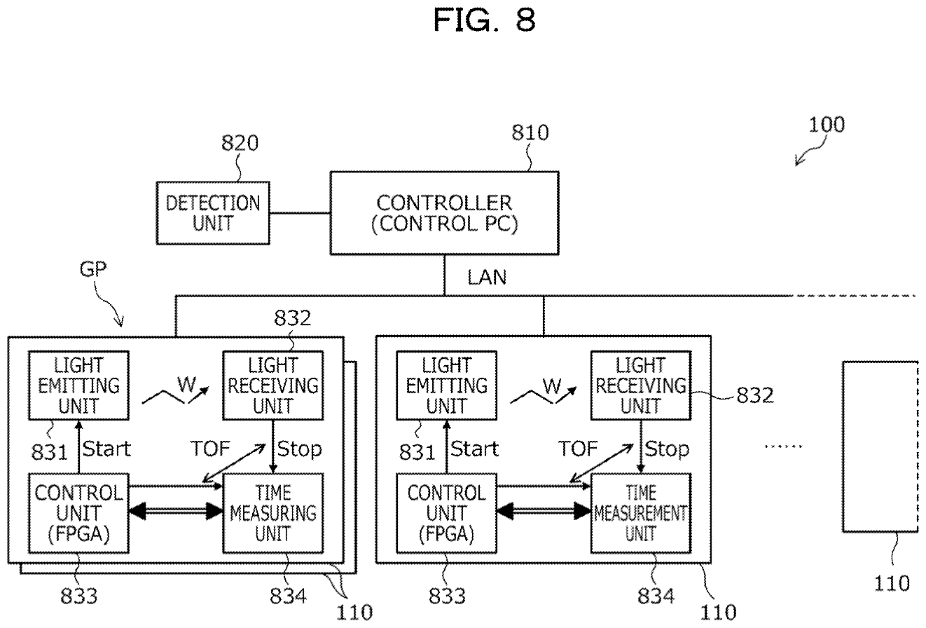

FIG. 8 illustrates a configuration example of a measurement system according to the embodiment. According to the configuration example illustrated in FIG. 8, the measurement system 100 includes the plurality of measurement apparatuses 110, a controller (control device) 810 such as a control PC that is communicably coupled to each of the measurement apparatuses 110 via a network such as a LAN, and a detection unit 820 that detects the position of a measurement target (athlete W). In a case where the measurement system 100 includes the controller 810, the detection unit 820 outputs a detection signal to the controller 810. When the measurement system 100 does not include the controller 810 and includes a plurality of measurement apparatuses 110 coupled in master/slave coupling, the detection unit 820 may output a detection signal to each of the measurement apparatuses 110.

FIG. 8 illustrates a configuration example in which, of the plurality of measurement apparatuses 110, only a pair of measurement apparatuses 110 that perform measurement are selected to be in the group GP (see FIG. 6).

The controller 810 collectively controls the plurality of measurement apparatuses 110. As the collective control, the controller 810 performs synchronization control under which the plurality of measurement apparatuses 110 cooperate with each other. Basically, under this synchronization control, the controller 810 performs control to cause all the measurement apparatuses 110 to emit the laser beams with the same wavelength at the same timing.

The controller 810 acquires, from the detection unit 820, information on the position of the measurement target (athlete W) on the balance beam 150. The controller 810 then selects a pair of measurement apparatuses 110 to be in the group GP in accordance with the detected position, and causes the pair of measurement apparatuses 110 selected to be in the group GP to start measurement under the normal mode. At this time, the controller 810 switches all the measurement apparatuses 110 other than the pair of measurement apparatuses 110 in the group GP performing the measurement, from the normal mode to the hold mode.

The pair of measurement apparatuses 110 selected to be in the group GP emit the laser beams onto the athlete W under the normal mode during the measurement period Ts. Under the hold mode, the other measurement apparatuses 110 not selected to be in the group GP stop emitting the laser beam during the measurement period Ts, and emit the laser beams during a period (for example, the flyback period Fb) other than the measurement period Ts.

The measurement apparatuses 110 each include a light emitting unit 831, a light receiving unit 832, a control unit 833, and a time measuring unit 834. The light emitting unit 831 includes a laser diode (LD), a MEMS mirror (corresponding to (c) in FIG. 2), a light projecting lens, an LD driving circuit, and the like, and the LD emits a laser beam (measurement beam). Under control by a MEMS driving unit, the MEMS mirror performs raster scanning, with the athlete W irradiated with the laser beam emitted from the light emitting unit 831 with the unique amplitude described above.

The light receiving unit 832 includes a light receiving lens and a photo sensor (PD), and the PD receives the reflected beam of the laser beam (measurement beam) with which the athlete W is irradiated.

A field programmable gate array (FPGA) may be used for the control unit 833. The control unit 833 controls the measurement apparatus 110 as a whole, and based on a control instruction from the controller 810, switches the host measurement apparatus 110 to the normal mode or the hold mode. The control unit 833 controls the driving of the laser beam emission for the light emitting unit 831, and performs data processing on the reflected beam (measurement data) received by the light receiving unit 832.

The time measuring unit 834 measures a time (TOF) from the light emission from the light emitting unit 831 to the light reception by the light receiving unit 832. The time measuring unit 834 acquires, from the control unit 833, the timing at which the light emitting unit 831 has started emitting the laser beam (Start), and detects, as AT, the time until the light receiving unit 832 detects the reflected beam from the measurement target (athlete W) (Stop). Based on the following Formula 1, the time measuring unit 834 outputs data on a distance L to the measurement target to the control unit 833:

L=(c×ΔT/2) Formula (1)

(where c=light speed≈300000 km/s).

The control unit 833 generates three dimensional measurement data including two dimensional (x, y) image data obtained as the reflected beam of the laser beam with which the raster scanning is performed on the measurement target, and the distance data. The measurement data is output to the controller 810. The controller 810 aggregates measurement data from the plurality of measurement apparatuses 110, executes image processing to generate image data including the outer edge of the body shape of the athlete W and colors representing different distances, and displays and outputs the image data (see (b) in FIG. 6).

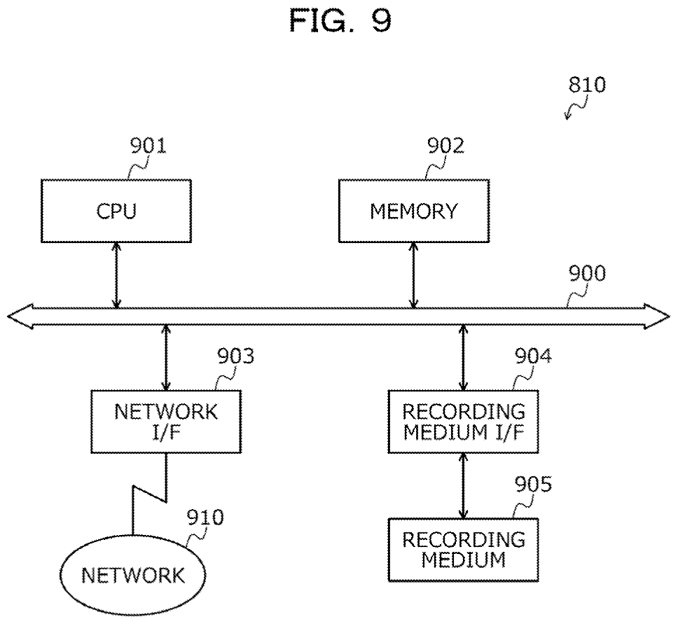

FIG. 9 illustrates a hardware configuration example of the controller. As the controller 810 described above, a computer device configured by hardware illustrated in FIG. 9 may be used.

For example, the controller 810 includes a central processing unit (CPU) 901, a memory 902, a network interface (IF) 903, a recording medium IF 904, and a recording medium 905. 900 is a bus through which the above blocks are coupled to each other.

The CPU 901 is an arithmetic processing device that functions as a control unit in charge of the entire processing of the controller 810. The memory 902 includes non-volatile memory and volatile memory. The non-volatile memory is, for example, a read-only memory (ROM) which stores a program for the CPU 901. The volatile memory is, for example, a dynamic random-access memory (DRAM), static random-access memory (SRAM), or the like used as a work area of the CPU 901.

The network IF 903 is an interface communicatively coupled to a network 910 such as a local area network (LAN), a wide area network (WAN), or the Internet. Through the network IF 903, the controller 810 may be communicably coupled to the measurement apparatus 110 or an external terminal (such as, for example, a terminal of a judge who scores artistic gymnastics).

The recording medium IF 904 is an interface for reading and writing information processed by the CPU 901 from and to the recording medium 905. The recording medium 905 is a recording device which assists the memory 902.

As the recording medium 905, for example, a hard disk drive (HDD), a solid state drive (SSD), a Universal Serial Bus (USB) flash drive, or the like may be used.

The CPU 901 may execute a program recorded in the memory 902 or the recording medium 905 so as to realize each function of the controller 810 illustrated in FIG. 8.

The hardware configuration illustrated in FIG. 9 may be applied to an external terminal (such as, for example, a PC or a smartphone) of the judge, and may be used instead of the FPGA 833 of the measurement apparatus 110.

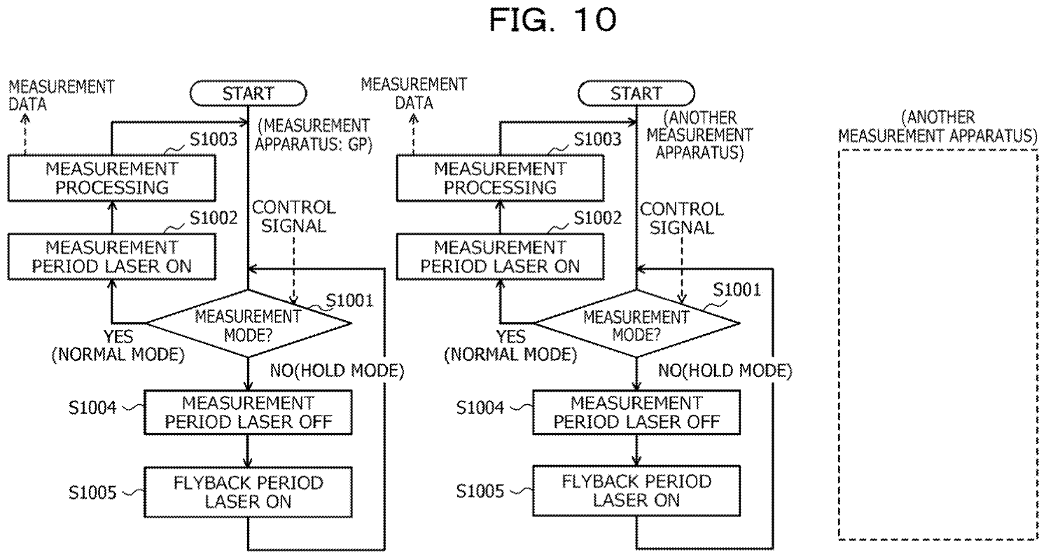

FIG. 10 is a flowchart illustrating a processing example of the measurement system according to the embodiment. While the processing executed by the plurality of measurement apparatuses 110 is described in FIG. 10, the pair of measurement apparatuses 110 selected to be in the group GP as described above similarly execute the processing (a series of processing by the left end group GP illustrated in FIG. 10, for example). A processing example executed by the control unit (FPGA 833) of the measurement apparatus 110 will be described.

The plurality of measurement apparatuses 110 cooperate to implement synchronization control, under the control of the controller 810. Based on the position of the measurement target (athlete W) detected by the detection unit 820, the controller 810 selects any pair of measurement apparatuses 110 to be in the group GP. The pair of measurement apparatuses 110 selected to be in the group GP perform measurement under the normal mode.

Each of the measurement apparatuses 110 determines whether to switch to the normal mode or the hold mode in accordance with the presence or absence of a control signal (measurement mode) from the controller 810 (step

S1001).

Upon receiving the control signal for starting the measurement (step S1001: Yes), the measurement apparatuses 110 selected to be in the group GP by the controller 810 transition to the normal mode to perform the measurement. During the measurement period Ts, the measurement apparatuses 110 selected to be in the group GP turn ON the laser beam emission (step S1002) and execute the measurement processing on the measurement target (athlete W) (step S1003). Thereafter, the measurement apparatuses 110 return to the processing in step S1001.

In the measurement processing in step S1003, the control unit (FPGA 833) of the measurement apparatus 110 performs raster scanning irradiation, using the laser beam emitted onto the measurement target (athlete W) during the measurement period Ts. The reflected beam from the measurement target (athlete W) is detected by the light receiving unit 832 of the measurement apparatus 110, and the measurement data (the two dimensional data and the distance information) is output to the controller 810.

The other measurement apparatuses 110 not selected to be in the group GP by the controller 810 are under the hold mode (hold mode ON) to not perform the measurement, in a period during which the control signal for starting the measurement is not received (step S1001: No). During the measurement period Ts, the measurement apparatus 110 turns OFF the laser beam emission (step S1004). During the flyback period Fb continuing to the measurement period Ts, the laser beam emission is turned ON (step S1005). Thereafter, the measurement apparatuses 110 return to the processing in step S1001.

The controller 810 may generate a signal indicating selection/non selection to be in the group GP, as the control signal. In this case, each of the measurement apparatuses 110 transitions to the normal mode based on the input of the control signal indicating the selection to be in the group GP, and transitions to the hold mode ON based on the input of the control signal indicating non selection to be in the group GP.

For the processing in FIG. 10, the processing described above executed by the measurement apparatuses 110 will be described using the group GP selection as an example. In a case where the position of the athlete W detected by the detection unit 820 corresponds to a pair of measurement apparatuses 110 among the plurality of measurement apparatuses 110, the controller 810 selects the pair of measurement apparatuses 110 to be in the group GP. The control signal for starting the measurement is output to the pair of measurement apparatuses 110 selected to be in the group GP. The series of processing at the left end in FIG. 10 corresponds to the processing executed by the pair of measurement apparatuses 110 selected to be in the group GP.

The controller 810 does not output the control signal for starting the measurement to the other measurement apparatuses 110 that are not selected to be in the group GP, and does not cause the other measurement apparatuses 110 to perform the measurement. During the period that is the same as the period during which the measurement apparatuses 110 selected to be in the group GP perform measurement processing, these measurement apparatuses 110 not selected to be in the group GP do not perform the measurement, but execute processing in step S1004 and step S1005, in which the hold mode is ON. A series of processing at the center of FIG. 10 corresponds to the processing executed by the other measurement apparatuses 110 not selected to be in the group GP.

(Measurement State of each Measurement Apparatus during Movement of Measurement Target)

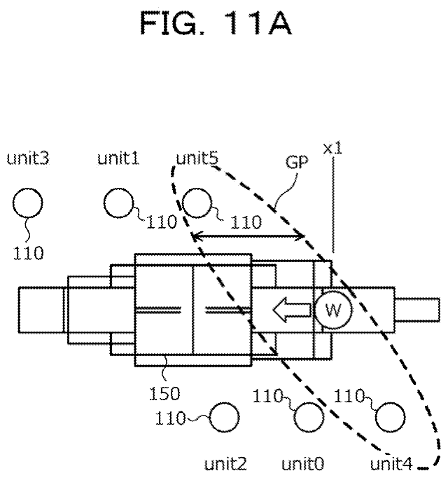

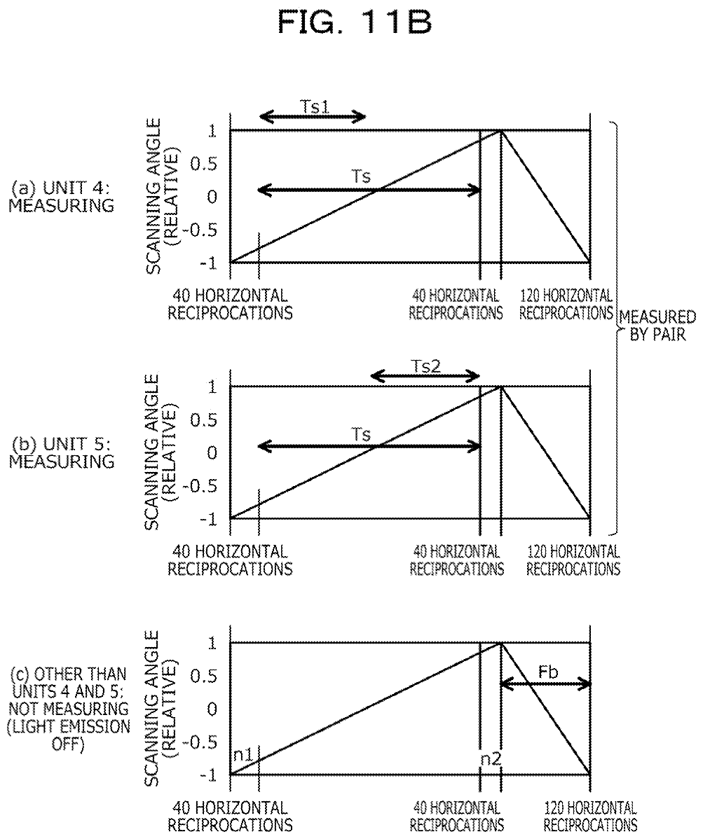

Next, a description will be given, with reference to FIGS. 11 to 13, of a measurement state of the measurement apparatuses 110 corresponding to the movement of the athlete W in a case where the measurement target (athlete W) performs a routine (elements) on the balance beam 150. Based on the position of the athlete W detected by the detection unit 820, the controller 810 selects the measurement apparatuses 110 to be in the group GP.

FIG. 11A is an explanatory diagram illustrating a measurement state of the measurement apparatuses during the movement of the measurement target. FIG. 11B is an explanatory diagram illustrating a laser beam emission state of the measurement apparatuses during the movement of the measurement target. FIG. 11B illustrates a vertical direction sampling region (the horizontal axis represents time (a horizontal reciprocal scanning period during which the MEMS reciprocates 200 times) and the vertical axis represents the scanning angle of the laser beam in the vertical direction).

As illustrated in FIG. 11A, in a case where the athlete W on the balance beam 150 is detected at x1, the controller 810 selects the measurement apparatuses 110 that are Unit 4 and Unit 5 to be in the group GP that emit laser beams (measurement beams) onto the position x1.

At this time, as illustrated in (a) in FIG. 11B, the measurement apparatus 110 that is Unit 4 selected by the controller 810 emits the laser beam under the normal mode in the measurement period Ts. Similarly, as illustrated in (b) in FIG. 11B, the measurement apparatus 110 that is Unit 5 selected by the controller 810 emits the laser beam in the measurement period Ts.

As illustrated in (c) in FIG. 11B, the measurement apparatuses 110 that are Unit 0 to Unit 3 (other than Units 4 and 5) not selected by the controller 810 stop the laser beam emission in the measurement period Ts, with the hold mode turned ON. These measurement apparatuses 110 that are Units 0 to 3 (other than Units 4 and 5) not selected by the controller 810 emit the laser beams in the flyback period Fb.

Thus, among the measurement apparatuses 110 that are Unit 0 to Unit 3 (other than Units 4 and 5) not selected by the controller 810, the measurement apparatuses 110 selected to be in the group GP after the end of the flyback period Fb may perform the measurement in a stable state at the start of the measurement period Ts.

The measurement apparatuses 110 that are Units 0 to 3 (other than Units 4 and 5) not selected by the controller 810 may perform the laser beam emission also during the periods of the dead zones n1 and n2 before and after the measurement period Ts, in addition to the flyback period Fb. Thus, among the measurement apparatuses 110 that are Units 0 to 3 (other than Units 4 and 5) not selected by the controller 810, the measurement apparatuses 110 selected to be in the group GP after the end of the flyback period Fb may perform the measurement in a more stable state at the start of the measurement period Ts.

The pair of measurement apparatuses 110 that are Units 4 and 5 selected to be in the group GP by the controller 810 emit the laser beams (measurement beams) toward the athlete W from the front and back sides of the balance beam 150. The controller 810 may control the pair of measurement apparatuses 110 that are Units 4 and 5 to emit the laser beams (measurement beams) in mutually different periods as a result of dividing the measurement period Ts.

As illustrated in (a) in FIG. 11B, the measurement apparatus 110 that is Unit 4 emits the laser beam (measurement beam) in a first half period Ts1 of the measurement period Ts. As illustrated in (b) in FIG. 11B, the measurement apparatus 110 that is Unit 5 emits the laser beam (measurement beam) in a second half period Ts2 of the measurement period Ts.

Alternatively, the pair of measurement apparatuses 110 that are Units 4 and 5 may both be controlled to emit the laser beams (measurement beams) in the same measurement period Ts, and the controller 810 may acquire the measurement data in the first half period Ts1 from the measurement apparatus 110 that is Unit 4, and acquire the measurement data in the second half period Ts2 from the measurement apparatus 110 that is Unit 5. Accordingly, it is possible to suppress interference or the like between the measurement apparatuses 110 that are Units 4 and 5 selected to be in the group GP.

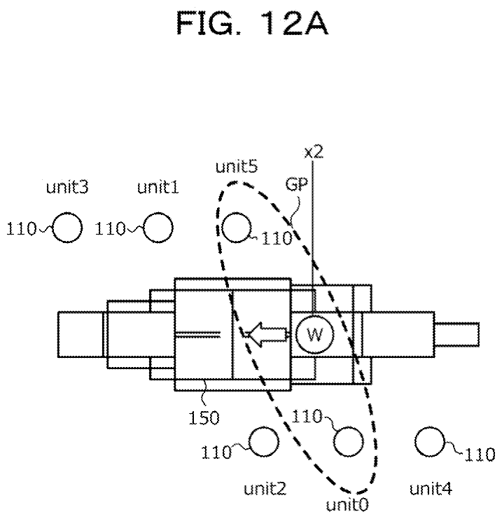

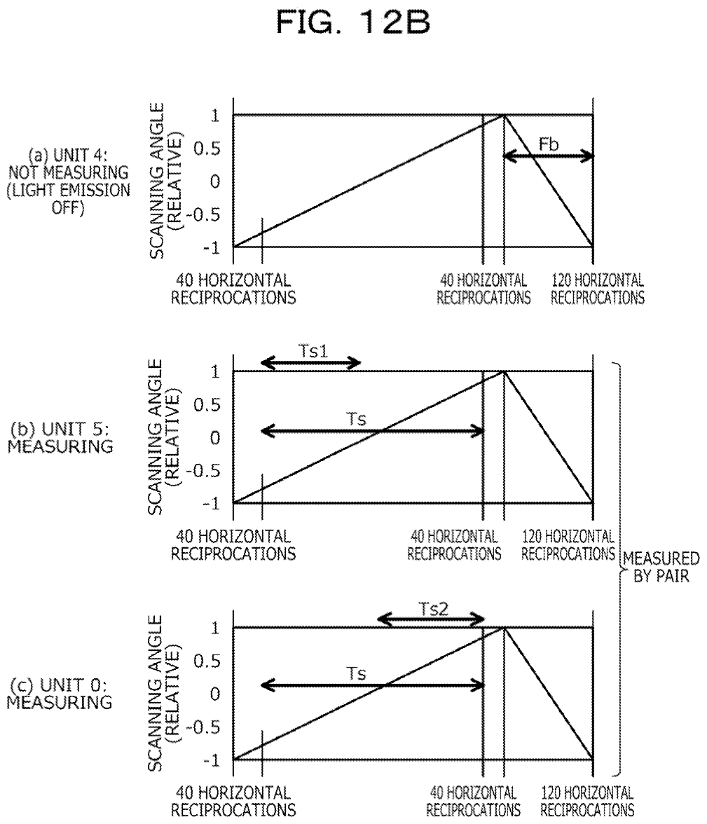

Next, it is assumed that the athlete W on the balance beam 150 illustrated in FIG. 11A has moved from the position x1 to the position x2. FIG. 12A is an explanatory diagram illustrating a measurement state of the measurement apparatuses during the movement of the measurement target. FIG. 12B is an explanatory diagram illustrating a laser beam emission state of the measurement apparatuses during the movement of the measurement target. As illustrated in FIG. 12A, the athlete W on the balance beam 150 is assumed to be detected at x2. The athlete W performing the routine (elements) moves in an unpredictable direction on the balance beam 150. This direction of movement is unable to be recognized in advance on the measurement system 100 side.

As illustrated in FIG. 12A, in a case where the athlete W is detected at x2, the controller 810 selects the measurement apparatuses 110 that are Unit 5 and Unit 0 to be in the group GP that emit laser beams (measurement beams) toward the position x2.

At this time, the measurement apparatuses 110 that are Units 1 to 4 (other than Units 0 and 5) not selected by the controller 810 stop the laser beam emission in the measurement period Ts, with the hold mode turned ON. These measurement apparatuses 110 that are Units 1 to 4 (other than Units 0 and 5) not selected by the controller 810 emit the laser beams in the flyback period Fb.

At this time, as illustrated in (a) in FIG. 12B, the measurement apparatus 110 that is Unit 4 not selected by the controller 810 stops the laser beam emission in the measurement period Ts with the hold mode turned ON.

The laser beam is emitted in the flyback period Fb.

As illustrated in (b) in FIG. 12B, the measurement apparatus 110 that is Unit 5 that has been continuously selected by the controller 810 from the state illustrated in FIG. 11A and (b) in FIG. 118 continuously emits the laser beam under the normal mode in the measurement period Ts.

As illustrated in (c) in FIG. 12B, the measurement apparatus 110 that is Unit 0 newly selected by the controller 810 starts emitting the laser beam under the normal mode in the measurement period Ts. In the immediately preceding state as illustrated in (c) in FIG. 118, this measurement apparatus 110 that is Unit 0 is in the state of emitting the laser beam in the flyback period Fb with the hold mode turned ON, and thus may perform the measurement in a stable state at the start of the measurement period Ts.

Also in the state illustrated in FIG. 12B, the measurement apparatuses 110 that are Units 1 to 4 (other than Units 0 and 5) not selected by the controller 810 may perform the laser beam emission also during the periods of the dead zones n1 and n2 before and after the measurement period Ts, in addition to the flyback period Fb. Thus, among the measurement apparatuses 110 that are Units 1 to 4 (other than Units 0 and 5) not selected by the controller 810, the measurement apparatuses 110 selected to be in the group GP after the end of the flyback period Fb may perform the measurement in a more stable state at the start of the measurement period Ts.

The measurement apparatuses 110 that are Units 0 and 5 selected to be in the group GP by the controller 810 may be controlled to emit the laser beams (measurement beams) in mutually different periods as a result of dividing the measurement period Ts. In the example illustrated in (b) in FIG. 12B, the measurement apparatus 110 that is Unit 5 emits the laser beam (measurement beam) in the first half period Ts1 of the measurement period Ts, and the measurement apparatus 110 that is Unit 0 emits the laser beam (measurement beam) in the second half period Ts2 of the measurement period Ts. Accordingly, it is possible to suppress interference or the like between the measurement apparatuses 110 that are Units 0 and 5 selected to be in the group GP.

The measurement apparatus 110 that is Unit 5 is emitting the laser beam in the second half period Ts2 as illustrated in (b) in FIG. 11B, and may also continuously emit the laser beam in the second half period Ts2 in (b) in FIG. 12B. For example, in a case where there is the measurement apparatus 110 that continuously emits the beam in the normal mode during the movement of the athlete W, the controller 810 causes the measurement apparatus 110 (Unit 5) that continuously emits the beam to continuously emit the beam in the same period in the measurement period Ts (second half period Ts2). The controller 810 may allocate the remaining measurement period (first half period Ts1) of the measurement period Ts to the measurement apparatus 110 (Unit 0) that newly performs the laser beam emission.

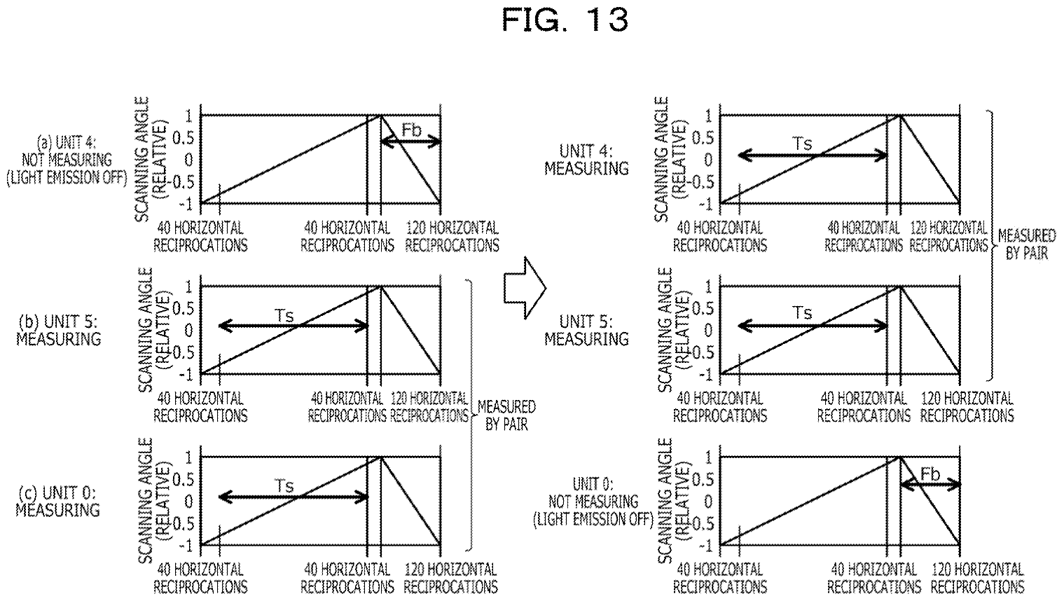

FIG. 13 illustrates transition of laser beam emission states of a plurality of measurement apparatuses. FIG. 13 illustrates a vertical direction sampling region (the horizontal axis represents time (a horizontal reciprocal scanning period during which the MEMS reciprocates 200 times) and the vertical axis represents the scanning angle of the laser beam in the vertical direction). On the left side of FIG. 13, laser beam emission states of the measurement apparatuses 110 that are Units 4, 5, and 0 at the time when the athlete W (position x2) on the balance beam 150 illustrated in FIG. 12 is detected are illustrated. On the right side, the laser beam emission states of the measurement apparatuses 110 that are Units 4, 5, and 0 at the time when the athlete W has moved back to the position x1 are illustrated.

The measurement apparatus 110 that is Unit 4 illustrated on the left side in (a) in FIG. 13 is in the laser beam emission stop (OFF) state during the measurement period Ts, and is in the laser beam emission (ON) state in the flyback period Fb, at the time when the athlete W (position x2) is detected. As illustrated on the right side of (a) in FIG. 13, when the athlete W is detected at the position x1, this measurement apparatus 110 that is Unit 4 transitions to the normal mode, and to transition to the laser beam emission (ON) stop state in the flyback period Fb and to the laser beam emission (ON) state in the measurement period Ts.

On the left side of (a) in FIG. 13 (the athlete W is at the position x2), this measurement apparatus 110 that is Unit 4 stops, and turns OFF the laser beam emission only in the measurement period Ts, and emits the laser beam in the flyback period Fb other than the measurement period Ts. Thus, on the right side of (b) in FIG. 13 (the athlete W is at the position x1), the MEMS is in the state where the specified amplitude is maintained at the start of the measurement period Ts, whereby the measurement may be immediately performed in the stable state from the start of the measurement period Ts.

The measurement apparatus 110 that is Unit 5 illustrated in (b) in FIG. 13 continuously performs the laser beam emission and performs the measurement in the measurement period Ts, even when the athlete W moves between the positions x1 and 2.

At the time when the athlete W (position x2) is detected, the measurement apparatus 110 that is Unit 0 illustrated in (c) in FIG. 13 is in the normal mode to perform the laser beam emission (ON) to perform the measurement in the measurement period Ts, and is in the laser beam emission stop (OFF) state in the flyback period Fb. As illustrated on the right side of (c) in

FIG. 13, when the athlete W is detected at the position x1, this measurement apparatus 110 that is Unit 0 transitions to the hold mode ON, and thus transitions to the laser beam emission stop (OFF) state in the measurement period Ts and to the laser beam emission (ON) state in the flyback period Fb.

This measurement apparatus 110 that is Unit 0 is in the laser beam emission (ON) state in the flyback period Fb. Thus, in a case where this measurement apparatus 110 that is Unit 0 is selected to be in the group GP by the controller 810 thereafter, the MEMS is in the state where the specified amplitude is maintained at the start of the measurement period Ts, whereby the measurement may be immediately performed in the stable state from the start of the measurement period Ts.

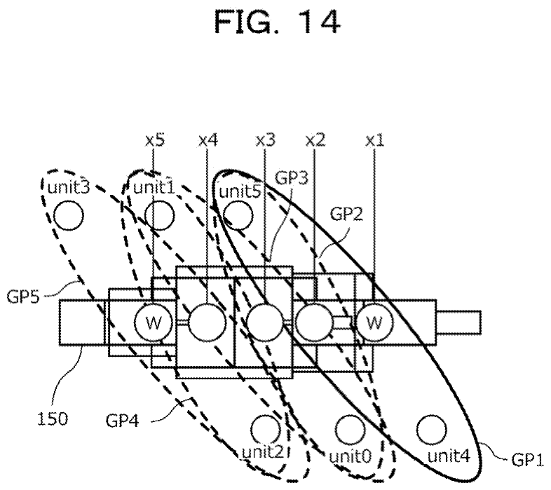

FIG. 14 illustrates an example of selection of a measurement apparatus in response to a movement of the measurement target. An example is described in which in response to the movement of the measurement target (athlete W) on the balance beam 150, the controller 810 selects the pair of front and back measurement apparatuses 110 to be in the group GP in accordance with the detected position of the athlete W.

In a case where the detection unit 820 detects the athlete W at the position x1, the controller 810 selects Units 4 and 5 to be in the group GP (GP1). In a case where the athlete W is detected at the position x2, the controller 810 selects Units 0 and 5 to be in the group GP (GP2). In a case where the athlete W is detected at a position x3, the controller 810 selects Units 0 and 1 to be in the group GP (GP3). In a case where the athlete W is detected at a position x4, the controller 810 selects Units 1 and 2 to be in the group GP (GP4). In a case where the athlete W is detected at a position x5, the controller 810 selects Units 2 and 3 to be in the group (GP5).

As illustrated in FIG. 14, the controller 810 selects a pair of measurement apparatuses 110 on the front and back sides of the balance beam 150 to be in the group in accordance with the position of the athlete W on the balance beam 150. The controller 810 then selects a pair of measurement apparatuses 110 corresponding to the position of the athlete W as a result of the movement, to be in the group. The controller 810 holds the setting in advance of the group of the pair of measurement apparatuses 110 corresponding to the position of the athlete W, and selects the group corresponding to the position detected by the detection unit 820.

For example, in the example illustrated in FIG. 14, in a case where the athlete W is detected at the position x1, Units 4 and 5 are selected to be in a group GP1, these measurement apparatuses 110 that are Units 4 and 5 transition to the normal mode, and the measurement apparatuses that are Units 0 to 3 other than Units 4 and 5 have the hold mode turned ON. In a case where the athlete W is detected at the position x2, Units 0 and 5 are selected to be in a group GP2, these measurement apparatuses 110 that are Units 0 and 5 transition to the normal mode, and the measurement apparatuses that are Units 1 to 4 other than Units 0 and 5 have the hold mode turned ON. In a case where the athlete W is detected at the position x5, Units 2 and 3 are selected to be in a group GPS, these measurement apparatuses 110 that are Units 2 and 3 transition to the normal mode, and the measurement apparatuses that are Units 0, 1, 4, and 5 other than Units 2 and 3 have the hold mode turned ON.

According to the embodiment described above, the plurality of measurement apparatuses cooperate to measure a measurement target moving, with a MEMS mirror performing raster scanning using laser beams with the same wavelength and with a synchronized measurement period. Of the plurality of measurement apparatuses, a first measurement apparatus corresponding to a detected position of the measurement target emits the laser beam onto the measurement target in the measurement period, to measure a distance to the measurement target based on the reflected beam from the measurement target. While the first measurement apparatus is emitting the laser beam onto the measurement target in the measurement period, a second measurement apparatus different from the first measurement apparatus emits the laser beam in a period other than the measurement period. Accordingly, it is possible to suppress interference with measurement by the first measurement apparatus from the second measurement apparatus. By causing the second measurement apparatus to emit the laser beam in a period other than the measurement period, measurement may be immediately started with high accuracy in a state where the laser oscillation state and the amplitude state of the MEMS mirror are stable at the time of remeasurement.

Each of the plurality of measurement apparatuses includes a light emitting unit configured to emit the laser beam, a light receiving unit configured to receive the reflected beam of the laser beam from the measurement target, and a time measuring unit configured to measure a time from emission of the laser beam to reception of the laser beam. The plurality of measurement apparatuses also includes a control unit configured to control the measurement apparatus, and output measurement data including data indicating the distance to the measurement target based on the time measured by the time measuring unit. Accordingly, the measurement apparatus may output three dimensional measurement data including two dimensional data of the x and y axes of the measurement target and distance information.

The plurality of measurement apparatuses may be communicably coupled to each other under master/slave setting and may each include a detection unit configured to detect the position of the measurement target. Of the measurement apparatuses, the first measurement apparatus corresponding to the position of the measurement target emits the laser beam onto the measurement target in the measurement period, and the second measurement apparatus different from the first measurement apparatus emits the laser beam in a period other than the measurement period, in which the first measurement apparatus is not emitting the laser beam. Accordingly, the plurality of measurement apparatuses cooperate with each other so that the measurement apparatus suitable for the measurement target may perform the measurement, and interference by the other measurement apparatuses with the measurement apparatus performing the measurement may be suppressed.

A configuration may be adopted that includes a controller that is communicably coupled to the plurality of measurement apparatuses and configured to perform synchronization control on the plurality of measurement apparatuses, and a detection unit configured to detect the position of the measurement target. The controller selects the first measurement apparatus corresponding to the position of the measurement target detected by the detection unit, and causes the first measurement apparatus to emit the laser beam onto the measurement target in the measurement period, and causes the second measurement apparatus different from the first measurement apparatus to emit the laser beam in a period other than the measurement period. Accordingly, the controller may make the plurality of measurement apparatuses cooperate with each other so that the measurement apparatus suitable for the measurement target may perform the measurement, and interference by the other measurement apparatuses with the measurement apparatus performing the measurement may be suppressed.

The second measurement apparatus may emit the laser beam in a flyback period that is a period, other than the measurement period, in which a vertical angle of the MEMS mirror returns to an initial position of the raster scanning. Even when the second measurement apparatus emits the laser beam in the flyback period, the measurement by the first measurement apparatus is not affected. By causing the second measurement apparatus to emit the laser beam in a period other than the measurement period, measurement may be immediately started with high accuracy in a state where the laser oscillation state and the amplitude state of the MEMS mirror are stable at the time of remeasurement.

The second measurement apparatus may increase output power of the laser beam during the flyback period. Accordingly, the output power of the laser beam in the flyback period may be approximated to the output power of the laser beam in the measurement period, and measurement may be immediately started with high accuracy in a state where the amplitude state of the MEMS mirror is stable at the time of remeasurement by the second measurement apparatus.

The plurality of measurement apparatuses may include one pair each of the measurement apparatuses arranged on front and back sides on a direction orthogonal to a movement direction of the measurement target, with the measurement target being at center. A pair of the measurement apparatuses corresponding to the position of the measurement target detected by the detection unit may be selected to be in a group of the first measurement apparatuses, and all of remaining ones of the measurement apparatuses not selected to be in the group may serve as the second measurement apparatuses. With the pair of measurement apparatuses thus measuring the measurement target, the measurement target may be measured from different directions at the same timing, whereby the measurement accuracy may be improved.

The measurement target may be an athlete moving back and forth in a length direction of a balance beam for artistic gymnastics. Because the athlete moves in an unpredictable direction on the balance beam, this direction of movement is unable to be identified in advance on the measurement system side. By causing the second measurement apparatus in a non-measurement state to emit the laser beam in the flyback period or the like other than the measurement period, measurement may be immediately started with high accuracy in a state where the laser oscillation state and the amplitude state of the MEMS mirror are stable at the time of remeasurement through the position detection of the measurement target.

With the above, in the embodiment, in a case where a plurality of measurement apparatuses using laser beams cooperate to measure a measurement target, interference by a laser beam from another measurement apparatus with the measurement apparatus performing the measurement may be suppressed. A reflected beam from the measurement target may enter the measurement apparatus performing the measurement, due to a movement of the measurement target in an unpredictable direction. In view of this, the measurement apparatus performing the measurement performs the measurement by emitting a laser beam in the measurement period, whereas the other measurement apparatuses emit a laser beam in a period other than the measurement period, so as not to interfere with the measurement during the measurement period. Without being limited to the above-described balance beam competition, the measurement system according to the embodiment is applicable to artistic gymnastics in general. Without being limited to the artistic gymnastics, the measurement system according to the embodiment is applicable to various measurement techniques in which a plurality of measurement apparatuses cooperate to measure a measurement target moving.

The measurement method described in the embodiment of the present disclosure may be enabled by causing a processor such as a server or the like to execute a program prepared in advance. The measurement method is recorded in a computer-readable recording medium such as a hard disk, a flexible disk, a compact disc-read only memory (CD-ROM), a digital versatile disk (DVD), or a flash memory and is executed after being read from the recording medium by the computer. The present measurement method may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A measurement system comprising
a plurality of measurement apparatuses configured to cooperate to measure a measurement target moving, with a MEMS mirror performing raster scanning using laser beams with a same wavelength and with a synchronized measurement period, wherein
of the plurality of measurement apparatuses, a first measurement apparatus corresponding to a detected position of the measurement target emits the laser beam onto the measurement target in the measurement period, to measure a distance to the measurement target based on a reflected beam from the measurement target, and
while the first measurement apparatus is emitting the laser beam onto the measurement target in the measurement period, a second measurement apparatus different from the first measurement apparatus emits the laser beam in a period other than the measurement period.

2. The measurement system according to claim 1, wherein each of the plurality of measurement apparatuses includes:
a light emitting unit configured to emit the laser beam;
a light receiving unit configured to receive the reflected beam of the laser beam from the measurement target;
a time measuring unit configured to measure a time from emission of the laser beam to reception of the laser beam; and
a control unit configured to control the measurement apparatus, and output measurement data including data indicating the distance to the measurement target based on the time measured by the time measuring unit.

3. The measurement system according to claim 1, wherein
the plurality of measurement apparatuses are communicably coupled to each other under master/slave setting,
each of the plurality of measurement apparatuses includes a detection device configured to detect the position of the measurement target,
the first measurement apparatus corresponding to the position of the measurement target emits the laser beam onto the measurement target in the measurement period, and
the second measurement apparatus different from the first measurement apparatus emits the laser beam in a period other than the measurement period, in which the first measurement apparatus is not emitting the laser beam.

4. The measurement system according to claim 1, the system further comprising:
a controller that is communicably coupled to the plurality of measurement apparatuses and configured to perform synchronization control on the plurality of measurement apparatuses; and
a detection device configured to detect the position of the measurement target, wherein
the controller is configured to:
select the first measurement apparatus corresponding to the position of the measurement target detected by the detection device;
cause the selected first measurement apparatus to emit the laser beam onto the measurement target in the measurement period; and
cause the second measurement apparatus different from the first measurement apparatus to emit the laser beam in a period other than the measurement period.

5. The measurement system according to claim 3, wherein
the second measurement apparatus emits the laser beam in a flyback period that is a period, other than the measurement period, in which a vertical angle of the MEMS mirror returns to an initial position of the raster scanning.

6. The measurement system according to claim 5, wherein
the second measurement apparatus increases output power of the laser beam during the flyback period.

7. The measurement system according to claim 1, wherein
the plurality of measurement apparatuses include one pair each of the measurement apparatuses arranged on front and back sides on a direction orthogonal to a movement direction of the measurement target, with the measurement target being at center,
a pair of the measurement apparatuses corresponding to the position of the measurement target detected by the detection device are selected to be used as the first measurement apparatus, and
all of remaining ones of the measurement apparatuses not selected to be in the group are used as the second measurement apparatus.

8. The measurement system according to claim 7, wherein
the measurement period is divided into a first half period in which the pair of measurement apparatuses emit the laser beams, and a second half period in which the measurement data is acquired.

9. The measurement system according to claim 1, wherein
the measurement target is an athlete moving back and forth in a length direction of a balance beam for artistic gymnastics.

10. A measurement apparatus comprising a MEMS mirror with which raster scanning is performed using a laser beam with a predetermined wavelength, to measure a measurement target moving, wherein
the measurement apparatus uses the laser beam with a same wavelength as another measurement apparatus, and measures the measurement target in a measurement period synchronized with the other measurement apparatus,
while being in a state of detecting the measurement target based on a detected position of the measurement target, the measurement apparatus emits the laser beam onto the measurement target in the measurement period, and measures a distance to the measurement target based on a reflected beam from the measurement target, and
while being in a state of not detecting the measurement target, the measurement apparatus emits the laser beam in a period other than the measurement period.

11. The measurement apparatus according to claim 10, wherein the measurement apparatus and the other measurement apparatus are under synchronization control, by being in master/slave coupling or based on control by a controller.

12. A computer-implemented method of measurement performed by a computer configured to cause a plurality of measurement apparatuses to cooperate to measure a measurement target moving, with a MEMS mirror performing raster scanning using laser beams with a same wavelength and with a synchronized measurement period, the method comprising:
causing, of the plurality of measurement apparatuses, a first measurement apparatus corresponding to a detected position of the measurement target to emit the laser beam onto the measurement target in the measurement period, to measure a distance to the measurement target based on a reflected beam from the measurement target; and
causing a second measurement apparatus different from the first measurement apparatus to emit the laser beam in a period other than the measurement period, in case that the first measurement apparatus is emitting the laser beam onto the measurement target in the measurement period.
